(19) United States
(12) Patent Application Publication
(10) Pub. No.: US 2017/0164566 A1
(43) Pub. Date: Jun. 15, 2017

(54) UMBRELLA-LIKE ASSEMBLY FOR RETAINING FLOWERS, PLANTS, OR OTHER ARTICLES

(71) Applicant: Leonard Wayne Stablum, Cataula, GA (US)

(72) Inventor: Leonard Wayne Stablum, Cataula, GA (US)

(21) Appl. No.: 14/658,519

(22) Filed: Mar. 16, 2015

(51) Int. Cl. A01G 9/12; A01G 9/02; A47B 81/00

(52) U.S. Cl. CPC A01G 9/12; A47B 81/00; A01G 9/02

(57) ABSTRACT

There is provided an assembly for retaining hanging plants or other botanicals items that evokes the pleasing visual aesthetic of an umbrella in that the ribs and other elements of the assembly extend from a central pole and provide an overall downwardly arching arrangement. The assembly can be shipped and stored in a convenient space saving configuration and can be easily assembled by a user.

### BACKGROUND OF THE INVENTION

Various arrangements are used for supporting potted plants and providing an aesthetic display, while ensuring adequate sunlight and watering conditions. A variety of plant containers such as, for example, hanging baskets, are used according to the plant characteristics. Many potted plants are moved indoors during the winter and are again moved outdoors during the summer.

One well known approach for displaying and fostering the growth o indoor plants involves planting the roots of such plants in a suspendable planter container that is individually suspended from the ceiling of a room, office, or hallway. Ropes, chains, or wires may be deployed to support the planter container from a bolt or a hook installed in the ceiling.

Indoor space is at a premium since the space with direct light is in most cases limited. Moreover, individual plants have different demands in terms of light exposure, watering, frequency of fertilizing, etc. Furthermore, when displaying potted plants in a vertical arrangement, the plants should preferably be arranged such that no plant blocks the natural light to the other plants.

U.S. Pat. No. 3,015,024 to Charchan discloses an illuminated flower pot holder which is anchored in the ground and has a plurality of support arms to support potted plants and which are provided with light bulbs adjacent to the potted plants or flowers. The flower pot stand also includes means for supporting other accessories such as a name plate or lamp shade.

U.S. Pat. No. 2,794,554 to Donner shows a flower pot stand which may be readily assembled and disassembled for shipping and storage. The stand comprises an upright tubular member formed in sessions having flat plate members secured thereto. A plurality of arms extend radially from the corners of the plates and are rotatably mounted thereon. The assembly including the arms may be revolved bodily with respect to the ground or floor. Also, the arms may be rotatably adjusted with respect to each other.

While the aforementioned flower and plant container and support structures may be adequate for the basic purpose and function for which they have been designed, there still exists a need for an aesthetically pleasing assembly for retaining hanging flowers or plants that overcomes the drawbacks of these prior approaches.

### SUMMARY OF THE INVENTION

It is therefore an object of the present invention to provide an assembly for retaining hanging plants or other botanicals items that can be shipped and stored in a convenient space saving configuration and can be easily assembled by a user.

Another object of this invention is to provide an aesthetically pleasing assembly for retaining handing plants that can be optimally manufactured with strength materials only where needed and with lightweight less expensive materials being used wherever possible, thus leading to a cost optimized yet durable product.

An additional object of this invention is to provide an assembly for retaining hanging plants or other botanicals items that evokes the pleasing visual aesthetic of an umbrella in that the ribs and other elements of the assembly extend from a central ogle and provide an overall downwardly arching arrangement.

A further elect of this invention is to provide assembly for retaining hanging plants or other botanicals items that is convenient to deploy and visually harmonious with many indoor and outdoor environments.

Another object of this invention is to provide an assembly for retaining hanging plants suitable for outdoor environments such as decks, patios, and poolside areas and suitable for indoor environments including rooms in residential buildings and offices, retail space, hallways, and lobbies of commercial buildings.

According to one aspect of the present invention, one configuration of an assembly for retaining hanging plants or other botanicals items that can be shipped and stored n a convenient space saving configuration and that can be easily assembled by a user is in the form of a hanging article assembly having a pole assembly, a receiver portion, a plurality of ribs, each rib being securable to the receiver portion, a decorative element on the receiver portion, and an overlay element associated with each rib, the decorative element on the receiver portion and the overlay element associated with each rib being coordinated with one another to provide a visual appearance evocative of a tree, a plant, or other botanical object. In accordance with further features of this one configuration of the assembly, the receiver portion may include a plurality of recesses each for receiving an end of a rib inserted therein and the decorative element associated with each rib may extend at least partially along the extent of the associated rib and the receiver portion includes a plurality of recesses each for receiving one end of a respective decorative element.

### BRIEF DESCRIPTION OF THE DRAWINGS

FIG. 1 a top perspective view of one embodiment of the assembly for retaining articles in a hanging condition of the present invention;

FIG. 2 is a top plan view of the one embodiment of the assembly for retaining articles;

FIG. 3 is a top perspective view of the one embodiment of the assembly for retaining articles showing the pole sub-assembly in exploded manner;

FIG. 4 is a front elevational view of the one embodiment of the assembly for retaining articles;

FIG. 5 is an enlarged perspective view of the crown mount and showing the proximate ends of the body portions of the ribs;

FIG. 6 is an enlarged perspective view of the crown mount and showing a rib and its associated rib overlay in exploded assembly manner:

FIG. 7 is a front perspective view of the unibody receiver portion of the one embodiment of the assembly for retaining articles;

FIG. 8 is a front perspective view of the unibody receiver portion of the one embodiment of the assembly for retaining articles; and

FIG. 9 is a front perspective view of a sectional receiver portion of the one embodiment of the assembly for retaining articles;

FIG. 10 is a front plan exploded view of the one embodiment of the assembly for retaining articles;

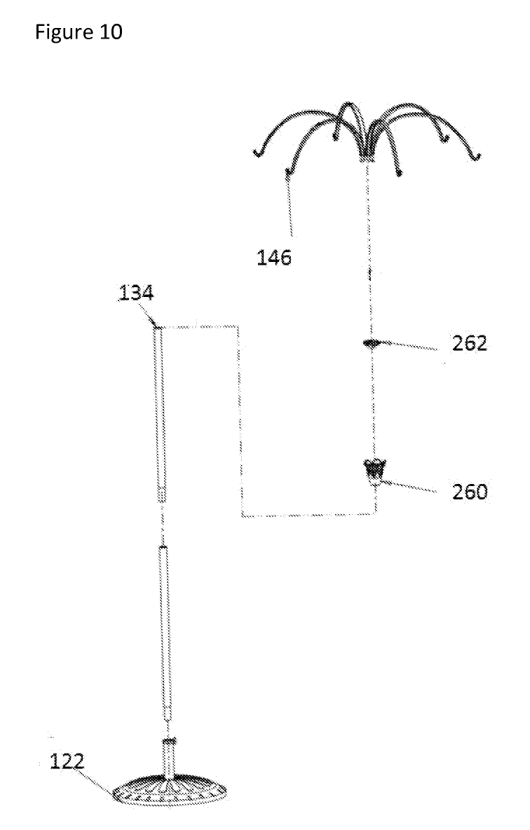

FIG. 11 is an enlarged perspective view of the crown mount and showing a rib and its associated rib overlay in exploded assembly manner; and

FIG. 12 is an enlarged perspective view of an native configuration of the crown mount and the ribs and snowing the proximate ends of the body portions of the ribs.

### DETAILED DESCRIPTION OF AN EMBODIMENT

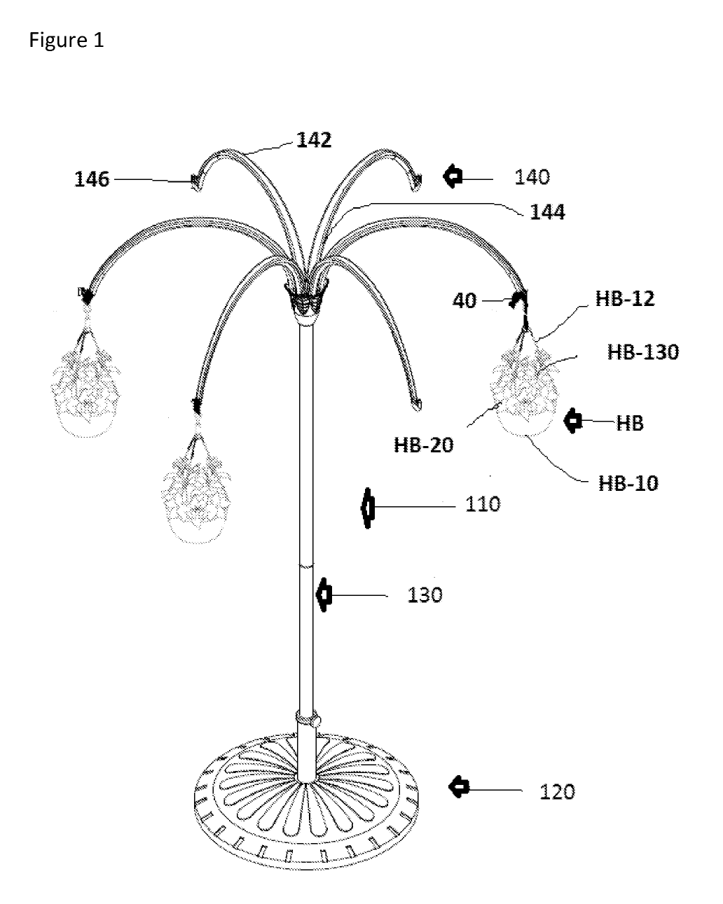

As seen in FIG. 1, which is a top perspective view of one embodiment of the assembly for retaining articles in a hanging condition, a retention assembly 110 is shown that includes a surface mount 120, a pole subassembly 130, and a multi-rib sub-assembly 140. Any suitable single article, or a group of articles, can be retained by the retention assembly 110 such that the article or articles are in a hanging condition.

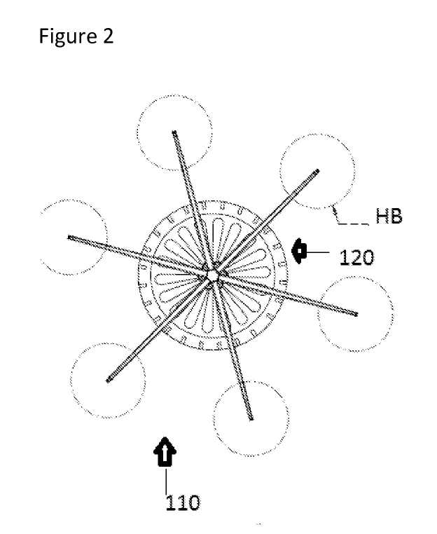

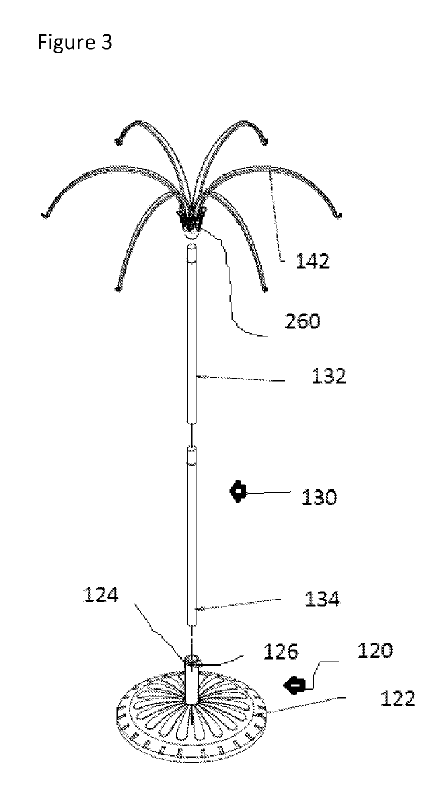

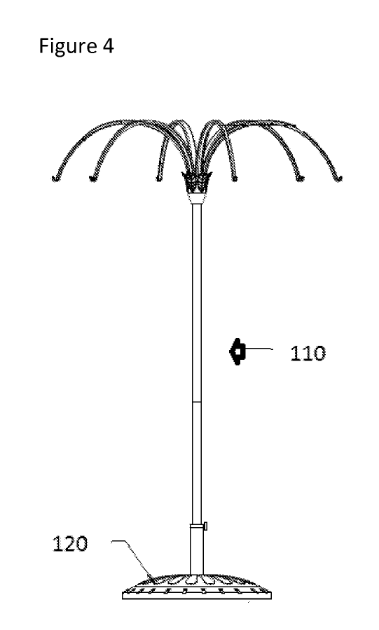

For further details about the one embodiment of the assembly for retaining articles, reference is additionally had to FIG. 2, which is a top plan view of the one embodiment of the assembly for retaining articles, FIG. 3, which is a top perspective view of the one embodiment of the assembly for retaining articles showing the pole sub-assembly in exploded manner, and FIG. 4, which is a front elevational view of the one embodiment of the assembly for retaining articles. Solely for the sake of illustration, the retention assembly 110 is shown as retaining a group of articles each of which is a hanging basket HB and each hanging basket HB comprises a container HB-10, a volume HB-20 of soil, nutrients, and/or other root support materials, and a botanical item HB-30 such as a plurality of flowers whose roots are embedded in the soil volume HB-20. Each container HB-10 has a plurality of cable strands HB-12 that each have an axial end connected to a top rim of the container HB-10 and an opposite axial end that is commonly joined with the opposite axial ends of the other cable strands HB-12 to a hook 40. Each hook 40 can be releasably secured to the retention assembly 110, in a manner described in more detail herein, so that each hanging basket HB hangs from the retention assembly 110. It can thus be understood that the retention assembly 110 provides a convenient and stable arrangement for displaying the group of hanging baskets HB in many environments such as a room of a house or an office or in a garden or a lawn.

Returning to additional details about the one embodiment of the assembly for retaining articles, reference is had to FIG. 3, which is a top perspective view of the one embodiment of the assembly for retaining articles showing the pole sub-assembly in exploded manner, wherein it can be seen that the pole sub-assembly 130 includes a pole segment 132 and a lower pole segment 134. The lower axial end of the pole segment 132 is provided with a reduced diameter section compatibly configured with the upper axial end of the lower pole segment 134 such that the lower axial end of the pole segment 132 can be inserted into the upper axial end of the lower pole segment 134 to be frictionally retained thereat in a friction fit. FIG. 3 also shows one representative configuration for the surface mount 120 in the form of an annular base plate 122 having a vertical hollow tube 124. The lower axial end of the lower pole segment 134 is received in the vertical hollow tube 124 and a cinch belt 126 is then tightened to apply radially inward pressure against the vertical hollow tube 124 to thereby promote the retention of the lower pole segment 134. The surface mount 120 can alternatively be configured for permanent installation in or slightly below ground level. For example, the surface mount 120 can be comprised solely of the vertical hollow tube 124 and an end user can install the vertical hollow tube 124 in an appropriately dimensioned hole in a grass lawn, a deck surface, or a concrete or asphalt surface. As desired, concrete or cement can be added to permanently secure the vertical hollow tube 124 in the hole.

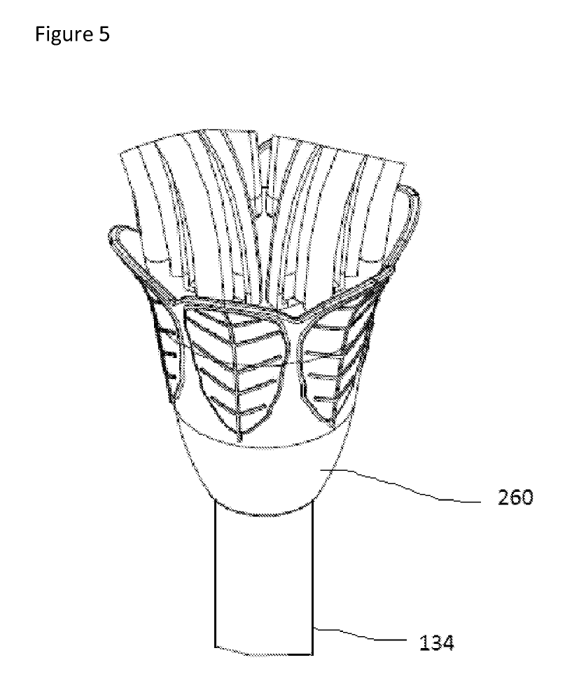

The multi-rib sub-assembly 140 includes a plurality of ribs 142 each of which extends radially relative to a pole axis PO-AX that is delimited by the pole sub-assembly 130. The ribs 142 are all commonly connected, via one of several securement arrangements to be described in more detail herein, to a receiver portion that is in the form of a crown mount 144. The crown mount 144 is mountable to a selected location on the pole sub-assembly 130 such as, for example, as seen in FIG. 1, to an axial end location on the pole sub-assembly 130. Each rib 142 has a body portion delimited by a proximate end 146 that is secured to the crown mount 144 and a distal end 148 that is at a greater radial spacing from the crown mount 144 than the proximate end 146 of the body portion. As seen in FIG. 5, which is an enlarged perspective view of the crown mount 144 and showing the proximate ends 146 of the body portions of the ribs 142, each of the ribs 142 is maintained by the crown mount 144 at a fixed circumferential spacing from the respective immediately adjacent ribs. Solely for the sake of illustration, the fixed circumferential spacing of each rib 142 from the respective immediately adjacent ribs is shown as a uniform circumferential spacing that is selected as a function of the total number of ribs 142. For example, if the total number of ribs 142 is a quantity of six (6) ribs, as shown in FIG. 1, then the fixed circumferential spacing of each no 142 from the respective immediately adjacent ribs is a uniform circumferential spacing equal to one-sixth of three hundred and sixty degrees—namely, a sixty (60) degree spacing [i.e., the circumference of a circle (360 degrees) divided by a total of six (6) ribs 142].

The distal end 148 of each rib 142 is formed with a generally U-shaped portion configured to receive a hook 40 of a respective basket HB-10 to be suspended from the rib. The hook 40 of the respective basket HB-10 and the generally U-shaped portion of the rib 142 remain movably interconnected to one another through a limited range of circumferential motion of the basket, whereupon an inadvertent collision with the basket will not mandatorily lead to a release of the basket HB-10 from the rib 142.

With further reference now to the several variations of the crown mount 144, the crown mount is configured to support the ribs 142 in a stable and aesthetically pleasing manner on the pole sub-assembly 130 and, as is available in some configurations of the retention assembly 110, to support decorative elements and functional elements in addition to the ribs 142 in a stable and aesthetically pleasing manner on the pole sub-assembly 130. As seen in FIG. 5, one configuration of the crown mount 144 is shown and the crown mount 144 includes a unibody receiver portion 260 and a connector member 262 that interconnects the unibody receiver portion 260 to the respective axial end of the pole sub-assembly 130 that is axially spaced from the other axial end of the pole sub-assembly connected to the surface mount 120. The proximate ends 146 of the ribs 142 are non-movably secured to the unibody receiver portion 260. The body portion of each rib 142 has an overall arcuate shape and each rib 142 extends from the unibody receiver portion 260 such that the inside portion of the arc delimited by the body portion of the rib is downwardly facing. An overlay element in the form of a rib overlay 150 is associated with each rib 142 and extends in generally conformity with the arcuate shape of the body portion of the rib. Each rib overlay 150 is secured to, or formed with, at least one of the respective associated rib 142 and the unibody receiver portion 260.

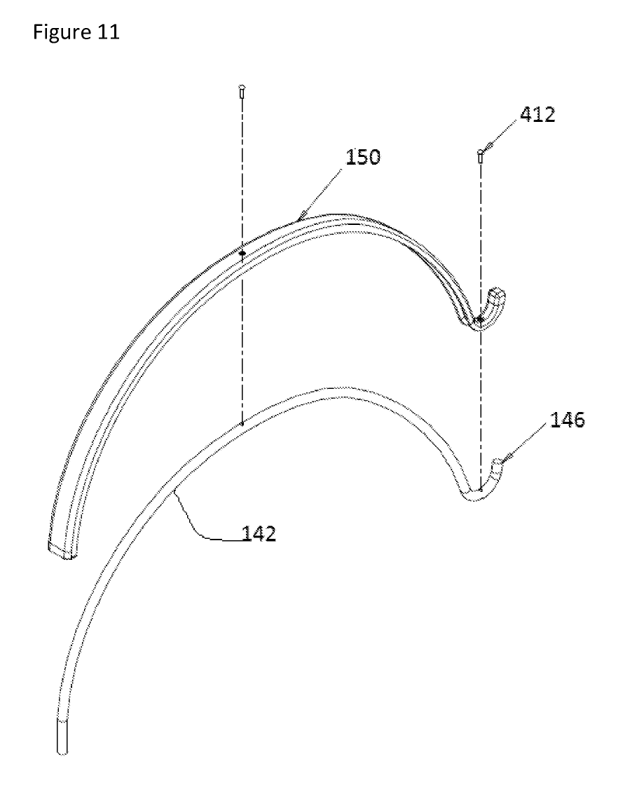

Each rib overlay 150 has an overall arcuate shape and includes a decorative feature in the form of a botanical leaf simulating structure 152. This decorative feature can be selected in coordination with a decorative feature, formed on the unibody receiver portion 260, that is also in the form of botanical leaf simulating structure and is exemplarily shown as a series of single leaf simulating crown facades 270 circumferentially arranged around the unibody receiver portion 260. It can be understood the visual effect of the rib overlays 150, with their botanical leaf simulating structures 152, in combination with the series of single leaf simulating crown facades 270 circumferentially arranged around the unibody receiver portion permit the retention assembly 110 to be evocative of a top-blooming type of botanical plant such as, for example, a palm tree or another type of botanical plant such as, for example, a shrub having fronds. The imagery evoked by the retention assembly 110 can be further reinforced if, for example, the botanical item HB-30 in each hanging basket HB 10 s flower or a plant. It is also to be understood that the rib overlays 150 need not manditorily comprise a visually precise rendering of a botanical structure such as a leaf but can, instead, be have a configuration and a visual appearance that complements the imagery evoked by the unibody receiver portion 260. For example, the rib overlays 150 can have a smooth slightly tapering visual appearance such as shown, for example, in FIG. 11, whereat it can be seen that the rib overlay 150 does not include the botanical leaf simulating structure 152.

FIG. 5 shows one exemplary approach for assembling the rib overlays 150, the ribs 142, and the unibody receiver portion 260 to one another. According to this exemplary approach, each rib 142 and each rib overlay 150 is provided as a stand-alone component that is individually installable the unibody receiver portion 260. The unibody receiver portion 260 is formed as a stand-alone component. Each rib 142 is secured to the unibody receiver portion 260 via, for example, insertion of the proximate end 146 of the rib 142 into a compatibly configured tubular recess 264. Each rib overlay 150 s secured to the unibody receiver portion 260 via, for example, insertion of an end of the rib overlay 150 into a compatibly configured right-angled cut-out 266.

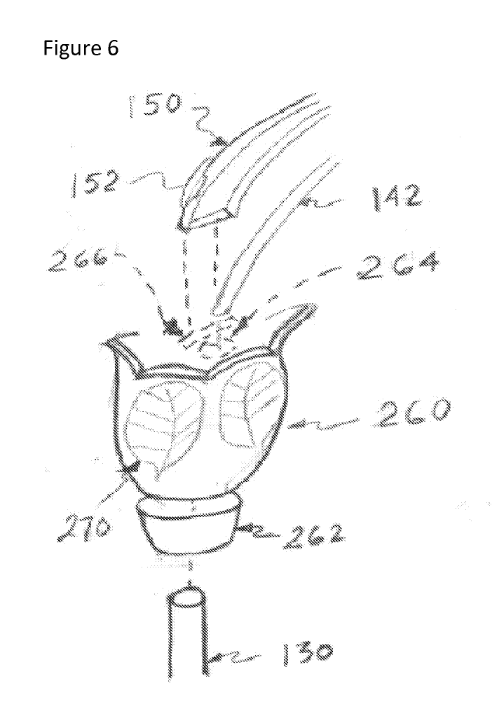

Reference is had to FIG. 6, which is an enlarged perspective view of the crown mount and showing a rib and its associated rib overlay in exploded assembly manner. In connection with the insertion of the proximate end 146 of the rib 142 into a compatibly configured tubular recess 264 of the unibody receiver portion 260, any suitable selectively releasable securement arrangement can additionally be provided to ensure that the rib 142 is stably secured to the unibody receiver portion 260. For example, the proximate end 146 of the rib 142 can be provided with the deflectable pair of arms forming a fork with the ends of the arms having enlarged portions each being receivable in a compatibly configured side detent formed on a side of the tubular recess 264. This arrangement permits a user to release the rib 142 from the unibody receiver portion 260 via a movement of the enlarged portions of the deflectable pair of arms out of their seated disposition in the side detents formed on the sides of the tubular recess 264 of the unibody receiver portion 260. Alternatively, glue, adhesive bonding, or a friction fit approach can be deployed to ensure the retention of the proximate end 146 of each rib 142 in its seated disposition in the tubular recess 264 of the unibody receiver portion 260

In connection with the insertion of the rib overlay 150 into a compatibly configured right angled cut-out 266 of the unibody receiver portion 260, any suitable selectively releasable securement arrangement can additionally be provided to ensure that the rib overlay 150 is stably secured to the unibody receiver portion 260. For example, the rib overlay 150 can be provided with the deflectable pair of arms forming a fork with the ends of the arms having enlarged portions each being receivable in a compatibly configured side detent formed on a side of the right-angled cut-out 266. This arrangement permits a user to release the rib overlay 150 from the unibody receiver portion 260 via a movement of the enlarged portions of the deflectable pair of arms out of their seated disposition in the side detents formed on the sides of the right-angled cut-out 266 of the unibody receiver portion 260. Alternatively, glue, adhesive bonding, or a friction fit approach can be deployed to ensure the retention of each rib overlay 150 in its seated disposition in a right-angled cut-out 266 of the unibody receiver portion 260. With regard to a further configuration possibility, reference is now had to FIG. 11, which is an enlarged perspective view of the crown mount and showing a and its associated rib overlay in exploded assembly manner. A plurality of threaded boas 412 can be provided, each of which can be threadably engaged with a tapped throughbore in each respective rib overlay 150 and threadably engaged with a tapped limited depth bore in each respective rib 142. The threaded bolts 412 thus fixedly retain each rib overlay 150 in engagement with the associated rib 142.

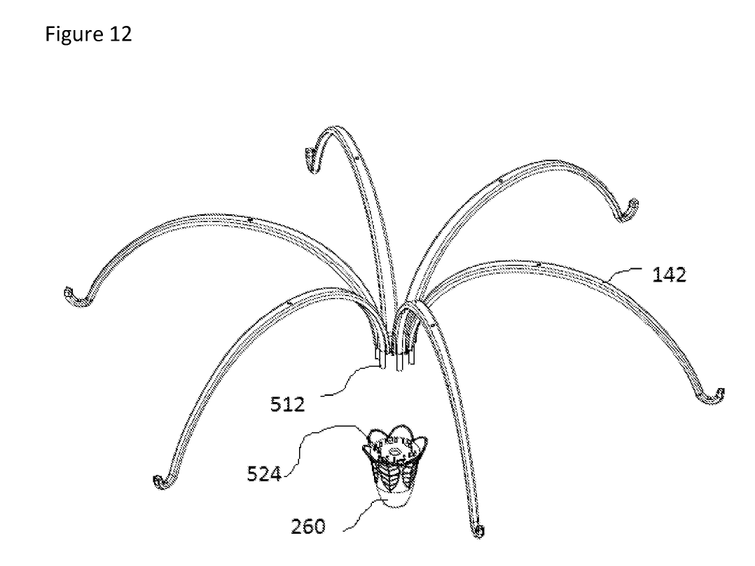

With regard to a further configuration possibility, reference is now had to FIG. 12, which is an enlarged perspective view of an alternative configuration of the crown mount and the ribs and showing the proximate ends of the body portions of the ribs. In this alternative configuration, the rib overlays 150 are secured to the ribs 142 and the rib overlays 150 are not separately secured to the unibody receiver portion 260. Here it can be seen that the proximate ends of the ribs 142 can be configured with a cylindrical peg 512 (in lieu of a deflectable pair of arms forming a fork) with each cylindrical peg 512 to be received in a respective cylindrical bore 524 formed in the crown mount 260 (in lieu of the tubular recess 264).

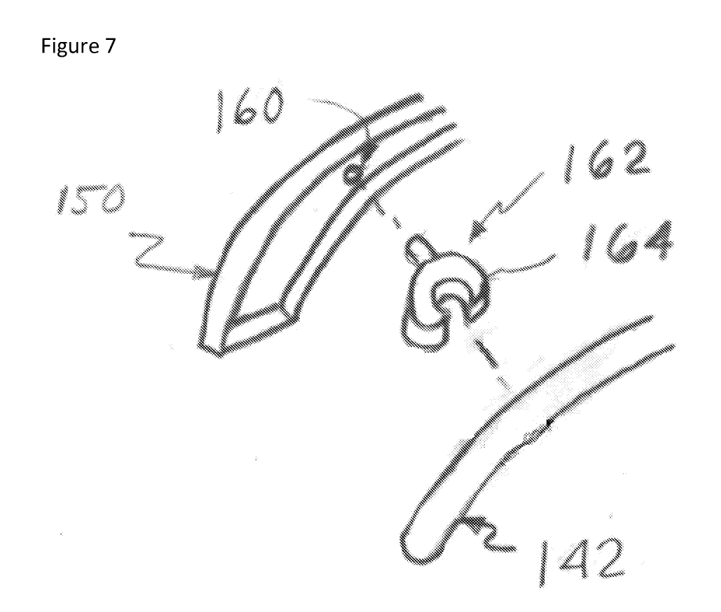

As seen in FIG. 7, which is a front perspective view of the unibody receiver portion, a rib overlay, and a rib, each rib overlay can be secured to the respective rib with which it is associated and, via this securement, be indirectly secured to the unibody receiver portion 260. A rib overlay 150 has a bore 160 that receives the post of a snap clip 162 in a friction fit manner and the snap clip 162 includes an encircling jaw that is releasably engageable around the rib 142.

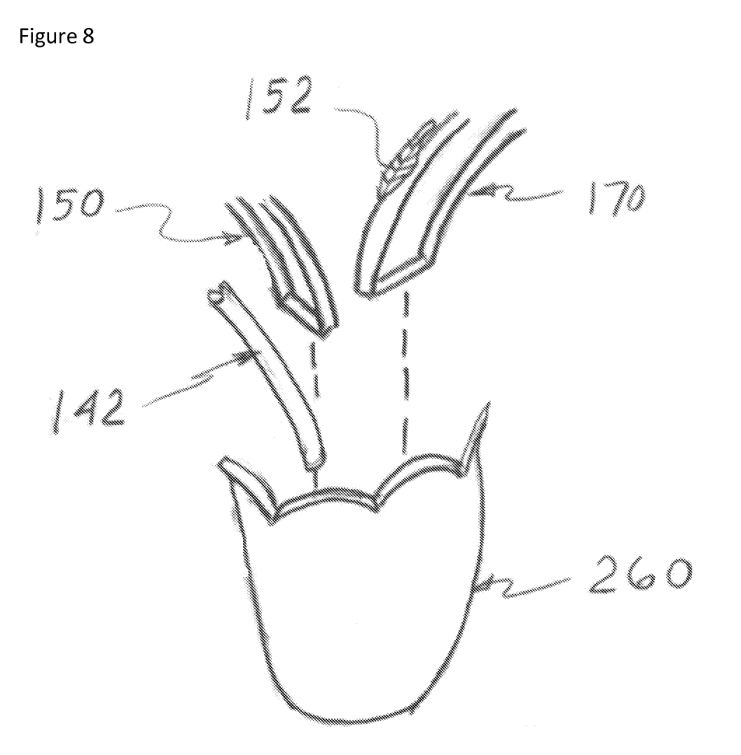

As seen in FIG. 8, which is a front perspective view of the unibody receiver portion 260, one or more decorative branches 170 can be provided to vary the visual effect of the retention assembly 110. A decorative branch 170, which can have the same botanical leaf simulating structure 152 as each rib overlay 150, is configured as a stand alone component that can extend radially from the unibody receiver portion 260 without resting upon, or being secured to, a respective rib 142. A plurality of decorative branches 170 can be arranged in interleaved manner with a plurality of rib and rib overlays combinations so that, for example, there is an equal number of decorative branches 170 and rib and rib overlays combinations. As the decorative branches 170 are not associated with ribs, a user can choose to not suspend a hanging basket HB-10 on the end of a decorative branch or, alternatively, each decorative branch 170 can be configured to receive a different type of hanging article than a hanging basket HB-10.

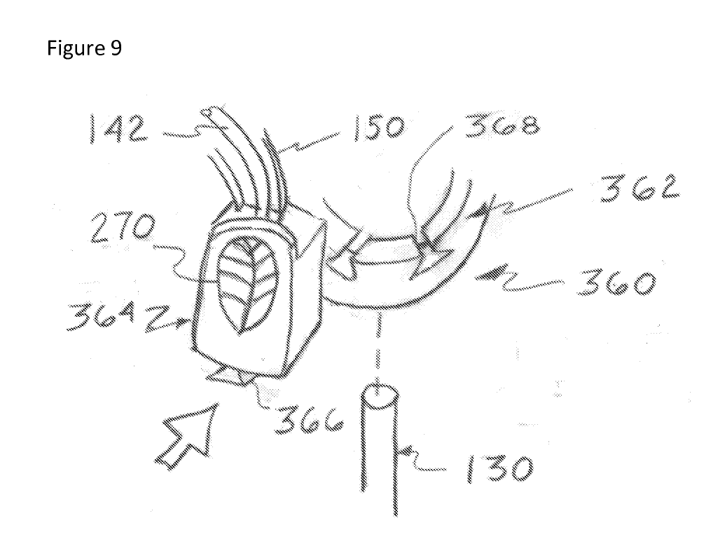

As seen in FIG. 9, which is a front perspective view of a sectional receiver portion, the retention assembly 110 can be configured with a plurality of sectional receiver sub-portions 360 in lieu of the unibody receiver portion 260. Each sectional receiver sub-portion 360 includes a keyway pate 362 and a plurality of circumference building blocks 364, one of which is shown in FIG. 9. Each circumference building block 364 includes a single leaf simulating crown facade 270. A rib 142 is secured to the sectional receiver portion 360 via, for example, insertion of the proximate end 146 of the rib 142 into a compatibly configured tubular recess. A rib overlay 150 is secured to the sectional receiver portion 360 via, for example, insertion of an end of the rib overlay 150 into a compatibly configured right-angled cut-out. The sectional receiver portion 360 includes a key 366 that can be seated in a respective one of a plurality of keyways 368 formed in the keyway plate 362 to thereby secure the sectional receives portion 360 to the keyway plate 362. As each sectional receiver sub-portion 360 is configured to receive and support a single rib 142, the number of sectional receiver sub-portions 360 can be selected as a function of the number of ribs 142 to be deployed. In addition, a rib 142 can be deliberately omitted from selected sectional receiver portions 360 to vary the appearance of the retention assembly 110.

It is contemplated that each rib 142 and each rib overlay 150 can be manufactured as a single piece item or, alternatively, can be manufactured in partial pieces to be assembled into a whole piece by the end user. In general, the retention assembly 110 facilitates the goal of providing an assembly for retaining hanging plants or other botanicals items that can be shipped and stored in a convenient space saving configuration and can be easily assembled by a user. Moreover, the configuration of the retention assembly 110 promotes the goal of providing an aesthetically pleasing assembly for retaining hanging plants that can be optimally manufactured with strength materials only where needed and with lightweight less expensive materials being used wherever possible, thus leading to a cost optimized yet durable product. With regard to suitable manufacturing variations, each rib 142, each rib overlay 150, and the unibody receiver portion 260 can be individually manufactured. Alternatively, each rib 142 and each associated rib overlay 150 can be manufactured as single integrally formed piece while the unibody receiver portion 260 is separately manufactured. As anther alternative, all of ribs 142, the rib overlays 150, and the unibody receiver portion 260 can be manufactured as a single integrally formed piece.

For the purpose of promoting an understanding of the present invention, references are made in the text to exemplary embodiments of a retention assembly for retaining flowers, plants, or other articles, only some of which are described herein. It should be understood that no limitations on the scope of the invention are intended by describing these exemplary embodiments. One of ordinary skill in the art will readily appreciate that alternate but functionally equivalent components and placement may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Although this invention has been disclosed and described in its preferred forms with a certain degree of particularity, it is to be realized that the optimum dimensional relationships for the parts of the invention, to include variations in size, materials, shape, form, function and manner of operation, assembly and use, are deemed readily apparent and obvious to one skilled in the art. Additionally, it is understood that the present disclosure of the preferred forms is only by way of example and that numerous changes in the details of operation and in the combination and arrangement of parts may be resorted to without departing from the spirit and scope of the invention as hereinafter claimed.

What is claimed is:

1. A hanging article assembly, comprising:
a pole assembly,
a receiver portion:
a plurality of ribs, each rib being securable to the receiver portion;
a decorative element on the receiver portion; and
an overlay element associated with each rib, the decorative element on the receiver portion and the overlay element associated with each rib being coordinated with one another to provide a visual appearance evocative of a tree, a plant, or other botanical object.

2. The assembly of claim 1, wherein the receiver portion includes a plurality of recesses each for receiving an end of a rib inserted therein.

3. The assembly of claim 2, wherein the decorative element associated with each rib extends at least partially along the extent of the associated rib and the receiver portion includes a plurality of recesses each for receiving one end of a respective decorative element.

4. The assembly of claim 3, wherein the pole assembly delimits a pole axis, the receiver portion is securable to one axial end of the pole assembly, each rib includes a body portion delimited by a proximate end and a distal end that is at a greater radial spacing from the receiver portion than the proximate end of the body portion, the proximate end of each rib terminates at the receiver portion, and the decorative element on the receiver portion extends axially beyond the termination of the proximate ends of the ribs at the receiver portion.

5. The assembly of claim 4, wherein the distal end of each rib is a hook.

6. The assembly of claim 5, wherein the pole assembly includes a plurality of segments that are interconnectable to each other in an end-to-end manner.

7. The assembly of claim 6 and further comprising a surface mount, the surface mount being operable to engage the lower axial end of the pole assembly and having at least one portion with an outer periphery that is at a greater radial spacing from the pole axis than the outer periphery of the pole assembly.
